(19) United States
(12) Patent Application Publication
(10) Pub. No.: US 2018/0194641 A1
(43) Pub. Date: Jul. 12, 2018

(54) UV-ABSORBING NANOCRYSTAL CONTAINING COMPOSITE

(71) Applicant: The Shepherd Color Company, Cincinnati, OH (US)

(72) Inventors: Christopher Wade Beier, Cincinnati, OH (US); William Michael Yuhasz, West Chester, OH (US); Mary Elizabeth Hillegass, Cincinnati, OH (US); Michael David Musick, Mason, OH (US)

(21) Appl. No.: 15/714,158

(22) PCT Filed: Mar. 29, 2016
(86) PCT No.: PCT/US2016/024688

§ 371 Date: Sep. 25, 2017

Related U.S. Application Data
(60) Provisional application No. 61/139,979, filed on Dec. 22, 2008.

(51) Int. Cl. C01F 17/00; C09C 1/00; C09C 1/30

(52) U.S. Cl. CPC C01F 17/0018; C09C 1/0081; C09C 1/3045; C01P 2002/02; C01P 2002/60; B82Y 30/00; C01P 2004/61; C01P 2004/62; C01P 2004/84; C01P 2006/60; C01P 2004/54

(57) ABSTRACT

A composite material comprising an amorphous, porous material with nanocrystalline material in its pores has been found to be a UV absorber. The porous material is a matrix of pores that act as a scaffold for the nanocrystalline material. The particles of the nanocrystalline material are isolated, which mean that they do not connect to each other. In some embodiments, the nanocrystalline material is completely inside the pores of the porous material. In some embodiments, the nanocrystalline material may stick out of some or all of the pores of the porous material. In some embodiments, the nanocrystalline material is a cerium oxide material. In some embodiments, the nanocrystallite ranges in size from 2 to about 100 nm on its longest axis, with an aspect ratio from about 1 to about 1.5.

### BACKGROUND

Ultraviolet (UV) light is a form of electromagnetic radiation at wavelengths between 10 and 400 nm. UV light is of higher energy than visible light, and accounts for approximately 10% of all light energy emitted from the Sun. Due to its energetic nature, UV light has the ability to induce chemical reactions and catalyze polymerizations. While beneficial in several instances, UV rays are also able to elicit significant damage to biological and inanimate objects alike. The absorption of ultraviolet radiation causes degradation through photo oxidation, whereby energetic UV photons destabilize chemical bonds and create a pathway that can lower the integrity of the material under irradiation.

The portion of the electromagnetic spectrum commonly designated as the UV portion ranges from wavelengths greater than 100 nm and less than 400 nm. This range is further subdivided into portions denoted as UV-A between wavelengths of 315 nm and 400 nm, UV-B between wavelengths of 280 nm and 315 nm, and UV-C between wavelengths 100 nm and 280 nm. UV-C light incident from the sun does not significantly penetrate the atmosphere and ozone layers, UV-B light is mostly absorbed by the upper atmosphere but not completely absorbed. The intensity reaching the surface varies seasonally and is a higher magnitude towards the equator than the poles. UV-A although less intense then UV-B light is a more predominant region of the UV spectrum. It penetrates clouds and is present any time there is sunlight, regardless of season or location.

As a result of the destructive nature of ultraviolet radiation, a myriad of molecules and materials have been developed to mitigate the potential harm UV light can induce. While initially effective, organic UV absorbers ultimately degrade, requiring custom designed solutions or additional additives that can improve their lifetime in increasingly harsh environments.

These UV absorbers function to enhance the lifetime of articles, coatings, plastics, or matrices in which they are contained. Functionally, they can be deployed in materials to provide protection of packaging, ingredients, contents, by decreasing spoilage rates, and maintaining structural integrity and clarity of packaging. UV absorbers added to cosmetics, creams, lotions, protect skin against harmful effects of exposure to sunlight. Combined over decorated wood stains, vinyl products, flooring, or metal coatings, UV absorbers help maintain coating adhesion to the substrate, minimize delamination of coatings, aid in corrosion protection for metals, For example, in automotive applications. UV absorbers increase lightfastness of organic colorants, slow the degradation of organic matrices such as wood fibers and polymers, and increase the lifetime of durable vinyl, plastic, and polymeric articles such as furniture, decking, floorings, siding, exterior goods, furniture, tarps, agriculture fabrics, automotive interiors, fibers, and films, among many other examples.

Inorganic oxides offer a solution to increased system stability, but, due to their inherently high refractive indices, have seen more use in opaque systems.

While traditionally used in opaque systems, inorganic oxide UV absorbers can be reduced in size to become non-opaque. As the size of the inorganic oxide reduces beyond the wavelength of incident light, its opacity will reduce.

Several inorganic species are known to function as good UV absorbers TiO₂, and ZnO are classically utilized in sunscreens and CeO₂ is more common in industrial wood coatings. TiO₂ provides sufficient protection at wavelengths less than 350 nm, it fails to provides adequate absorption between 350 nm and 400 nm. ZnO provides greater protection between 350 nm and 400 nm but can be less stable in acidic environments. Both oxides can be photo catalytically active and may require additional treatments to protect the matrices in which they are deployed from degradation. CeO₂ is noted as the most permanent UV absorber, offering reducing photocatalytic activity, high acid resistance, and high thermal stability.

However, for TiO₂, ZnO, or CeO₂ to be ultimately effective UV absorber, permanent, transparent, and broadly applicable, it is necessary to reduce the active nanocrystallite size. Particle sizes less than 150 nm in mean diameter are most useful. While traditionally used in opaque systems, inorganic oxide UV absorbers can be reduced in size to become non-opaque. As the size of the inorganic oxide reduces beyond the wavelength of incident light, its opacity will reduce.

These materials classified as nanoparticles have unusual challenges; The small size leads to high surface area and very strong agglomeration forces, thus, properly dispersing the materials is challenging, often these are provided as dilute liquid suspensions. The suspensions must have compatibility between the liquid containing the UV absorber and the medium in which they are to be deployed. Specific modifications are required for the nanoparticle UV absorbers in water-bourne, or solvent-bourne systems.

Furthermore, safety considerations for exposure to powdered nanoparticles have not been fully evaluated. Deliberations of both respiratory, ingestion and topical application of the nanomaterials are ongoing by many regulatory agencies. The very small size of the nanoparticles may permit particles to migrate through layers of skin, mucous membranes, out of matrices, penetrate filters, or diffuse in air great distances, increasing respiratory exposure. These concerns not only impact the manufacturing methods, utility, and application methods of nanoparticle containing UV absorbers but also, the long-term environmental impact of nanoparticles as they are ultimately released into the environment.

### BRIEF SUMMARY

A UV absorber composite comprises a nanocrystalline material and a porous material. The nanocrystalline material is in the pores of the porous material and is isolated. The nanocrystalline material comprises a cerium oxide material. Optionally, additional nanocrystalline materials may be present in the porous material; the composite may be encapsulated by an inorganic oxide; or both.

A UV absorber composite comprises a nanocrystalline material and a porous material. The nanocrystalline material is in the pores of the porous material. The nanocrystallite ranges in size from 2 to about 100 nm on its longest axis, with an aspect ratio from about 1 to about 1.5.

### BRIEF DESCRIPTION OF THE FIGURES

The accompanying drawings, which are incorporated in and constitute a part of this specification, illustrate embodiments, and together with the general description given above, and the detailed description of the embodiments given below, serve to explain the principles of the present disclosure.

FIG. 1a is a transmission electron microscope image of the composite of Example 1. FIG. 1b is a transmission electron microscope image of the composite of Example 4.

FIG. 2a is a transmission electron microscope image of a composite of Example 1. FIG. 2b is a transmission electron microscope image of a composite of Example 9.

FIG. 3 is a UV-Vis transmission spectrum of Example 15.

FIG. 4 is a UV-Vis diffuse reflectance spectrum of Examples 1, 2, and 3.

FIG. 5 is a UV-Vis diffuse reflectance spectrum of Examples 1, 4, 5, 6, 7, and 8.

FIG. 6 is a UV-Vis diffuse reflectance spectrum of Examples 1, 9, 10, 11, 12, and 13.

FIG. 7 is a UV-Vis transmission spectrum of Examples 1 and 3 dispersed in polystyrene resin as described in Example 16

FIG. 8 is a UV-Vis transmission spectrum of Examples 1, 4, 5, 6, 7, and 8 dispersed in polystyrene resin as described in Example 16

FIG. 9 is a UV-Vis transmission spectrum of Examples 1, 9, 10, 11, 12, and 13 dispersed in polystyrene resin as described in Example 16

FIG. 10 is a photo of Examples 1, 4, 5, 6, 7, and 8 dispersed in a polycarbonate (PC) resin and molded into a plastic chip as described in Example 17.

FIG. 11 is a photo of Examples 1, 3, 4, 5, 6, 7, 8, 9, 10, 11, 12, and 13 dispersed in a polystyrene (PS) resin and molded into a plastic chip as described in Example 16.

### DETAILED DESCRIPTION

A composite material comprising an amorphous, porous material with nanocrystalline material in its pores has been found to be a UV absorber. The random distribution of pores within the porous material act as a scaffold for the nanocrystalline material. The pores are isolated which means that they do not connect. The pores host the particles in the nanocrystalline material and keep them isolated, i.e., prevent them from contacting each other. The pores are open to the surface of the porous material. In some embodiments, the nanocrystalline material is completely inside the pores of the porous material. In some embodiments, the nanocrystalline material may stick out of some or all of the pores of the porous material. In some embodiments, a majority of the nanocrystalline material in within the pores of the porous material. In some embodiments, a majority of the nanocrystalline material is completely inside the pores of the porous material. In some embodiments, the nanocrystalline material is a cerium oxide material. In some embodiments, the nanocrystalline material has nanocrystallite ranges in size from 2 nm to about 100 nm on its longest axis, with an aspect ratio from about 1 to about 1.5. A nanocrystallite is a single crystal. Particles of the nanocrystalline material may be made up of multiple nanocrystallites.

The porous material is an inorganic amorphous material. In some embodiments, the pores in the porous material are about 0.5 nm to about 150 nm in diameter, such as from about 0.5 nm to about 100 nm, from about 0.5 nm to about 80 nm, from about 1 nm to about 80 nm, from about 1 nm to about 50 nm, from about 2 nm to about 50 nm, from about 3 nm to about 40 nm, from about 5 nm to about 150 nm, from about 5 nm to about 100 nm, from about 5 nm to about 75 nm, from about 5 nm to about 50 nm, from about 10 nm to about 150 nm, from about 10 nm to about 100 nm, from about 10 nm to about 75 nm, from about 10 nm to about 50 nm. The diameter of the pores is the diameter at the surface of the porous material. The interior diameter may be larger or smaller. In some embodiments, the porous material has a cumulative pore volume of about 0.1 to about 4 cm³/g, such as about 0.1 to about 2 cm³/g, about 0.1 to about 1 cm³/g, about 0.1 to about 0.8 cm³/g, about 0.25 to about 0.8 cm³/g, or about 0.25 to about 0.7 cm³/g. In some embodiments, the porous material has a particle size of about 0.5 m to about 15 m, such as from about 0.5 m to about 10 m, from about 0.5 m to about 7 m, about 0.5 m to about 5 m, or about 0.5 m to about 3.5 m. The diameter of the pores, the cumulative pore volume, and the particle size of the porous material may be of any combination described.

The porous material may contain a distribution of pores depending on the manufacturer and grade of material. Most commonly, the materials contain a distribution of pore diameters, for example 16-24 nm diameter, still others grades may contain a population of pores described as <100 nm in diameter with still numerous pore distributions from 0.5 nm to about 150 nm. Furthermore, amorphous silica are characterized by the specific surface area from 25-750 m²/g, such as 100-390 m²/g and 80-190 m²/g. In some embodiments, the porous material has a particle size of about 0.5 m to about 350 m, such as about 0.3 m to about 150 m, such as about 0.3 m to about 100 m, such as about 0.3 m to about 50 m, such as about 0.3 m to about 20 m, such as about 5 m to about 150 m, such as about 10 m to about 150 m, such as about 0.3 m to about 0.5 m, about 0.8 m to about 1.4 m, about 2 m to about 5 m. Any number of attrition, milling, or classification steps may be useful to reduce or modify the particle size distribution of the porous material. The diameter of the pores, the specific surface area, and the particle size of the porous material may be of any combination described.

In some embodiments, the porous material is a ceramic. In some embodiments, the porous material is silica, such as, but not limited to: amorphous fumed silica (e.g., Cab-o-Sil, Syloid, Tixosil, or Aerosil), amorphous precipitated silica (e.g., Zeolex, Zeosyl, or Ultrasil), or naturally occurring silica (e.g., diatomaceous earth).

The nanocrystalline material is in the pores of the porous material, so they are on or near the surface of the porous material, not fully encapsulated by the porous material. In some embodiments, the nanocrystalline material is entrained within the pores. In some embodiments, the nanocrystalline material is a cerium oxide material. Examples of cerium oxide material include, but are not limited to materials with the empirical formula of CeₓM_{y}O_{z}, wherein 0.5<x≤1, and 0≤y≤1, and 2.0≤z≤7; such as 0.5<x≤1, and 0≤y<0.5, and 2.0≤z≤7. The metal M is selected from Hf⁴⁺, Ta⁵⁺, W⁴⁺, Pr³⁺, Pr⁴⁺, Nd³⁺, Pm³⁺, Sm²⁺, Sm³⁺, Eu²⁺, Eu³⁺, Gd³⁺, Tb³⁺, Tb⁴⁺, Dy³⁺, Ho³⁺, Er³⁺, Tm²⁺, Tm³⁺, Yb²⁺, Yb³⁺, Lu³⁺, V³⁺, V⁴⁺, V⁵⁺, Bi³⁺, Bi⁵⁺, Mo⁴⁺, Mo⁶⁺, Mg²⁺, Ti³⁺, Ti⁴⁺, Si⁴⁺, Zn²⁺, Al³⁺, Zr⁴⁺, La³⁺, Sb⁵⁺, Nb⁵⁺, Co²⁺, Co³⁺, Mn²⁺, Mn³⁺, Ca²⁺, Sr²⁺, Ba²⁺, Fe⁴⁺, Fe³⁺, Fe²⁺, Cr³⁺, Sn⁴⁺, Y³⁺, Cu²⁺, Cu³⁺, or mixtures thereof; such as V³⁺, V⁴⁺, V⁵⁺, Bi³⁺, Bi⁵⁺, Mo⁴⁺, Mo⁶⁺, Mg²⁺, Ti⁴⁺, Si⁴⁺, Zn²⁺, Al³⁺, Zr⁴⁺, La³⁺, Sb⁵⁺, Nb⁵⁺, Co²⁺, Co³⁺, Mn²⁺, Mn³⁺, Ca²⁺, Sr²⁺, Ba²⁺, Fe⁴⁺, Fe³⁺, Fe²⁺, Cr³⁺, Sn⁴⁺, or mixtures thereof; or Ti⁴⁺, Si⁴⁺, Zn²⁺, Co²⁺, Co³⁺, Ca²⁺, Sr²⁺, Ba²⁺, Fe⁴⁺, Fe³⁺, Fe²⁺, Cr³⁺, Sn⁴⁺, or mixtures thereof. Examples include, but are not limited to: CeO₂, Ce_{0.9}Ca_{0.2}O₂, Ce_{0.8}Ca_{0.4}O₂, Ce₂O₃, Ce_{0.9}Fe_{0.13}O₂, Ce_{0.6}Cr_{0.53}O₂, SrTiO₃, CeAlO₃, and (Co,Zn)₂SiO₄. In some embodiments, the nanocrystalline material is CeAlO₃. In some embodiments, regardless of the M, the nanocrystalline material crystalline domain ranges in size from about 2 to about 100 nm on its longest axis, and the crystalline aspect ratio is from about 1 to about 1.5

In some embodiments, the nanocrystalline material crystalline domain ranges in size from about 2 to about 100 nm on its longest axis, such as: from about 2 nm to about 100 nm, from about 2 nm to about 80 nm, from about 2 nm to about 50 nm, from about 2 nm to about 40 nm, from about 5 nm to about 100 nm, from about 5 nm to about 80 nm, from about 5 nm to about 75 nm, from about 5 nm to about 50 nm, from about 5 nm to about 40 nm, from about 5 nm to about 30 nm, from about 10 nm to about 100 nm, from about 10 nm to about 800 nm, from about 10 nm to about 75 nm, from about 10 nm to about 50 nm. In some embodiments, the crystalline aspect ratio is from about 1 to about 1.5. In some embodiments, the nanocrystalline material will be about 2 nm to about 10 nm in diameter, such as about 2 nm to about 5 nm or about 5 nm to about 10 nm. In some embodiments, the aspect ratio is from about 1 to about 1.2. The size of the crystalline domain, the crystalline aspect ratio, and the diameter of the nanocrystalline material may be of any combination described. A plurality of crystalline domain ranges may be present. In some embodiments, there is more than one nanocrystalline material and they may have the same or different crystalline domain ranges.

In some embodiments, the structure of the nanocrystalline material is cubic fluorite structure. In some embodiments, the structure of the nanocrystalline material is tetragonal. In some embodiments, the structure of the nanocrystalline material is hexagonal. In some embodiments, the structure of the nanocrystalline material is pevorskite.

In some embodiments, the composite material additionally comprises a second nanocrystalline material. The second nanocrystalline material is in the pores of the porous material and is isolated. The second nanocrystalline material is selected from TiO₂, ZnO, MoO₃, (Co,Zn)₂SiO₄, SrTiO₃, and mixtures thereof. In some embodiments, the second nanocrystalline material can be another composition of cerium oxide nanocrystalline material. In some embodiments, the second nanocrystalline material has nanocrystallite ranges in size from 2 nm to about 50 nm on its longest axis, such as: from about 2 nm to about 100 nm, from about 2 nm to about 80 nm, from about 2 nm to about 50 nm, from about 2 nm to about 40 nm, from about 5 nm to about 100 nm, from about 5 nm to about 80 nm, from about 5 nm to about 75 nm, from about 5 nm to about 50 nm, from about 5 nm to about 40 nm, from about 5 nm to about 30 nm, from about 10 nm to about 100 nm, from about 10 nm to about 800 nm, from about 10 nm to about 75 nm, from about 10 nm to about 50 nm. In some embodiments, the crystalline aspect ratio is from about 1 to about 1.5. A nanocrystallite is a single crystal. Particles of the second nanocrystalline material may be made up of multiple nanocrystallites. In some embodiments, the second nanocrystalline material occupies pores in the porous material that also contain the cerium oxide nanocrystalline material.

In some embodiments, the second nanocrystalline material crystalline domain ranges in size from about 2 to about 50 nm on its longest axis, such as: from about 2 nm to about 100 nm, from about 2 nm to about 80 nm, from about 2 nm to about 50 nm, from about 2 nm to about 40 nm, from about 5 nm to about 100 nm, from about 5 nm to about 80 nm, from about 5 nm to about 75 nm, from about 5 nm to about 50 nm, from about 5 nm to about 40 nm, from about 5 nm to about 30 nm, from about 10 nm to about 100 nm, from about 10 nm to about 800 nm, from about 10 nm to about 75 nm, from about 10 nm to about 50 nm. In some embodiments, the crystalline aspect ratio is from about 1 to about 1.5. In some embodiments, the second nanocrystalline material will be about 2 nm to about 10 nm in diameter, such as about 2 nm to about 5 nm or about 5 nm to about 10 nm. In some embodiments, the aspect ratio is from about 1 to about 1.2. The size of the crystalline domain, the crystalline aspect ratio, and the diameter of the second nanocrystalline material may be of any combination described.

In some embodiments, the second nanocrystalline material may exist with different structures that the nanocrystalline material. In some embodiments, the TiO₂ structure is anatase, rutile, or a combination thereof. In some embodiments, the average TiO₂ nanocrystallites are smaller than 100 nm in diameter. In some embodiments, the ZnO structure is wurtzite, zinc blend, Rochelle salt, or a combination thereof. In some embodiments, the average ZnO nanocrystallites are smaller than 100 nm in diameter. In some embodiments, the MoO₃ structure is orthorhombic, hexagonal, or combinations thereof. In some embodiments, the SrTiO₃ is a perovskite structure. In some embodiments, the (Co,Zn)₂SiO₄ structure is a phenacite structure, or a willemite with hexagonal, rhomberhedral, or tetragonal forms.

In some embodiments, the amount of the total nanocrystalline material (including any second nanocrystalline material) does not exceed 62.5 wt % of the mass of the composite, such as, but not limited to between about 2 and about 62 wt %, between about 5 and about 60 wt %, between about 5 and about 50 wt %, between about 5 and about 43 wt %, between about 5 and about 40 wt %, and between about 5 and about 35 wt %.

In its powdered, undiluted form, the composite absorbs from about 50% to about 100% of the light with wavelengths between 200 and 375 nm, such as from about 50% to about 75%, from about 50% to about 70%, from about 70% to about 80%, and from about 75% to about 100%.

In some embodiments, the mean bulk aggregate size of the composite is from about 0.5 m to about 300 m, such as from about 0.5 m to about 200 m, from about 0.5 m to about 150 m, about 0.5 m to about 50 m, or about 0.5 m to about 20 m. In some embodiments, the mean bulk aggregate size of the composite is from about 0.2 m to about 2 m, such as from about 0.2 m to about 1 m, from about 0.2 m to about 0.8 m, or about 0.2 m to about 0.5 m.

The composite can be formed by incipient wetness methods. For example, a nanocrystalline precursor material is dissolved in a solvent, such as water. The porous material is added to the solution to form a viscous gel. The total volume of the liquid mixture added is less than or equal to the total pore volume of the porous material. The viscous gel is thoroughly mixed. The solvent is evaporated from the viscous gel to produce a dried cake. Then the dried cake is calcined above the nanocrystalline precursors decomposition temperature to produce the composite. The composite may be further processed by milling, such as jet milling to reduce the particle size or break up agglomerates.

The nanocrystalline precursor material is soluble in a solvent and contains the metal(s) needed in the empirical formula described above (i.e., CeₓM_{y}O_{z}), often with a complementary anion. For example, NO₃⁻, Cl⁻, SO₄²⁻, CH₃COO⁻, C₅H₇O₂⁻, C₂O₄⁻, PO₄³⁻, Br⁻, I⁻, CO₃²⁻, and HCO₃⁻ are anions which can form soluble species with one or more of the aforementioned metals in polar or non-polar solvents. In some embodiments, more than one nanocrystalline precursor material is used to form the nanocrystalline material. In some embodiments, only one nanocrystalline precursor material is used. During the calcination the precursor materials thermally decompose into the component oxide.

Solvents that may be used in the incipient wetness method for making the composite are ones that can at least partially dissolve the nanocrystalline precursor material and do not destroy the porous material.

The composite material comprising a second nanocrystalline material may be made by the same methods for making the composite material comprising the cerium oxide nanocrystalline material. Precursors for making the TiO₂ second nanocrystalline material include, but are not limited to: titanium boride, titanium chloride, titanium bromide, titanium butoxide, titanium ethoxide, titanium ethylhexanoate, titanium hydride, titanium isopropoxide, titanium nitride, titanium propoxide, titanium lactate, titanium sulfate, titanium oxysulfate, and mixtures thereof. Precursors for making the ZnO second nanocrystalline material include, but are not limited to: zinc acetate, zinc bromide, zinc chloride, zinc nitrate, zinc butoxide, zinc carbonate, zinc citrate, zinc oxalate, zinc sulfate, and mixtures thereof. Precursors for making the MoO₃ second nanocrystalline material include, but are not limited to: molybdenum acetate, molybdenum borohydride, molybdenum chloride, molybdenum isopropoxide, molybdenum sulfide, molybdic acid, molybdenyl acetylacetonate, molybdophosphoric acid, and mixtures thereof. Precursors for making the (Co,Zn)₂SiO₄ second nanocrystalline material include, but are not limited to: cobalt bromide, cobalt chloride, cobalt gluconate, cobalt hydroxide, cobalt isopropoxide, cobalt nitrate, and mixtures thereof; and strontium acetate, strontium bromide, strontium chloride, strontium isopropoxide, strontium nitrate, strontium sulfate, strontium oxalate, and mixtures thereof. Precursors for making the SrTiO₃ second nanocrystalline material include, but are not limited to: strontium acetate, strontium bromide, strontium chloride, strontium isopropoxide, strontium nitrate, strontium sulfate, strontium oxalate, and mixtures thereof; and titanium boride, titanium chloride, titanium bromide, titanium butoxide, titanium ethoxide, titanium ethylhexanoate, titanium hydride, titanium isopropoxide, titanium nitride, titanium propoxide, titanium lactate, titanium sulfate, titanium oxysulfate, and mixtures thereof. These precursor materials may be used in combination to make mixtures of the second nanocrystalline material.

In some embodiments, the composite is encapsulated partially or fully with a coating. When the composite is partially encapsulated, at least half of the composite is encapsulated, but the coating need not be contiguous. Example coatings include oxides and silicates of Al, Zr, Si, Bi, and W (or mixtures thereof), such as: SiO₂, Al₂O₃, Bi₂O₃, Bi₂SiO₅, WO₃, ZrO₂. In some embodiments the coating is selected from SiO₂ and Al₂O₃. The coating may be formed from tungsten boride, tungsten chloride, tungsten ethoxide, tungsten isopropoxide, tungstic acid; zirconium acetate, zirconium butoxide, zirconium carbonate, zirconium boride, zirconium bromide, zirconium carbonate hydroxide, zirconium chloride, zirconium oxychloride, zirconium oxynitrate, zirconium hydride, zirconium isopropoxide, zirconium lactate, zirconium sulfate, zirconium propoxide, zirconyl perchlorate; bismuth acetate, bismuth bromide, bismuth citrate, bismuth carbonate, bismuth, ethylhexanoate, bismuth hydroxide, bismuth isopropoxide, bismuth phosphate, bismuth sulfate, bismuth oxychloride, bismuth chloride, bismuth nitrate, bismuth oxynitrate, bismuth perchlorate; silicic acid, silicon tetraacetate, silicon chloride, silicon bromide, trimethylsilyl iodine, sodium silicate, tetraethylorthosilicate, potassium silicate, colloidal silica, silanes, tetraethylorthosilicate; aluminum ammonium sulfate, aluminum acetate, aluminum bromide, aluminum chloride, aluminum butoxide, aluminum isopropoxide, aluminum nitrate, aluminum oxalate, aluminum sulfate, aluminum lactate, aluminum metaphosphate; and related compounds, as well as mixtures thereof.

The composite may be coated by mixing the porous material containing the nanocrystalline material with an aqueous or solvent based metal salt or complex solution of one or more of the solubilized starting materials. Optionally, the pH of the solution may be adjusted, for example, with 3M NaOH, 3M H₂SO₄, phosphoric acid, ammonia, ammonium hydroxide, or acetic acid to the appropriate pH or stoichiometric ratio. The pH is selected to induce destabilization of the metal salt solution.

In some embodiments, the coating may be formed on the UV absorber composite by mixing the composite in the presence of aqueous or solvent based metal salt or complex solution containing one or more of the solubilized raw materials. Optionally, the pH of the solution may be adjusted, for example, with 3M NaOH, 3M H₂SO₄, phosphoric acid, ammonia, ammonium hydroxide, or acetic acid to the appropriate pH or stoichiometric ratio. The pH is selected to induce destabilization of the metal salt solution upon addition to the UV absorber composite.

In some embodiments, the coating may be formed by adding a solution containing the dissolved metal salt under agitation to a 0.5 to 50 weight percent solution of the UV absorber composite. The solution is allowed to equilibrate before the precipitation of the metal salt(s). Reactions that utilize colloidal silica are started identically. Commonly, metal alkoxide raw materials are deposited from alcohol solution in which an agent drives hydrolysis of the metal alkoxide and the formation of metal hydroxide or oxide. All reactions may or may not contain additional complexation aids and may be performed at elevated temperature to further induce precipitation and condensation of the shell onto the UV absorber composite.

The precipitation reaction may be controlled by a careful adjustment to the isoelectric point of the particle for deposition of colloidal particles or below the pH where instant precipitation of the metal oxide species occurs. Slow addition of the acid or base is accomplished by tittering in a small amount of acid or base at a known rate. Reaction rates vary significantly depending upon the concentration of the acid or base, the buffering power of the solution, the temperature of the reaction, and the rate of addition. In some embodiments, the precipitated material deposits onto the porous particles resulting in a homogenous shell of measurable thickness. In some embodiments, the roughness and density of the shell material varies with composition. In some embodiments, the inorganic oxide encapsulating material may occupy a portion of or completely fill the remaining pore structure of the amorphous material.

In some embodiments, the encapsulation is a composite of more than one material. The encapsulation can be deposited through simultaneous solvation of the metal complexes into water or solvent and exposure to the UV absorber composite as described above. For example, solutions of zirconium oxychloride and sodium silicate can be deposited simultaneously by slowly adjusting the pH from 12 with 3M H₂SO₄ through pH 8. In some embodiments, cross-reaction and complex formation is permitted with the precursor materials provided the by-products deposit onto or into the porous substrate.

In some embodiments, it is not necessary that the encapsulated material completely encase the UV absorber composite. In some embodiments, the metal oxide covers the pores containing the nanocrystalline material. In some embodiments, after deposition of the encapsulating material, new hybrid compounds may be added that yield an encapsulation containing entrained organic or inorganic materials. Likewise, deposition of the encapsulation material may be onto the porous material or exposed nanocrystalline material.

In some embodiments, calcinations of the coated core material may be required to promote crystallization, densification, dehydration, or solidification of the shell materials or condensation of any surface pendant hydroxyl groups to oxide to form the encapsulation. The temperature and time is dependent upon the material of composition but example ranges are from about 150 to about 1000 degrees Celsius, with dwell times from about 30 to about 600 minutes. Formation of crystalline material may be adjusted by correcting the calcination temperatures to promote only condensation for the formation of glass-like shells or amorphous metal oxides. Additionally, this step may be completed concurrently with the formation of the UV absorbing nanocrystallite material or separately; singularly or in multiple steps to increasing temperatures.

The composite may be used in coatings, such as paints, lacquers, and varnish; plastic; fibers; rubbers; elastomers; films; inks; cosmetics; ceramics, such as porcelain enamels, glass enamels; fabrics; concretes; decks; metal coatings; furniture; cements; asphalts; wood coatings; and similar articles. The composite may be used in polymeric matrixes, such as, but not limited to thermosetting matrix and thermoplastic matrices and for plastic and paper-board packaging, food contact applications, automotive interior parts, and automotive exterior parts.

Laser-marking is the function of generating an irreversible contrasting color change on an item by exposure of an item to a laser beam. It is particularly useful when the color change is patterned or scribed into characters, pictures, or patterns. The technology is exercised by several fields for the purpose of identification or decoration.

Laser-marking additives function by converting laser light at a selective wavelength into a chemical change that yields an observable contrast. Articles containing an effective amount of laser marking additives are impinged by a laser beam and the additive within the area experiences a chemical transformation that when inspected under illumination produces an identifiable contrast between the irradiated and non-irradiated areas of the article. Although, inspection of the article under illumination by visible light is the most common, the definition of a laser marker does not require visible light be used only that the there is a contrast detectable by some spectra of light between the irradiated and non-irradiated regions of the article.

Laser marking of many materials such as plastics and packaging is accomplished by the addition of an additive material sensitive to exposure to laser irradiation. Exposure to a laser results in a color changes that contrasts the base color of the material. The UV absorber composite may be used as a laser-marking additive.

A multitude of lasers wavelengths can be utilized with successful marking depending on the chemical properties of the additives. The UV absorber composite is particularly useful when processed with a UV lasers. However, other laser wavelengths may be useful in laser-marking the UV absorber composite.

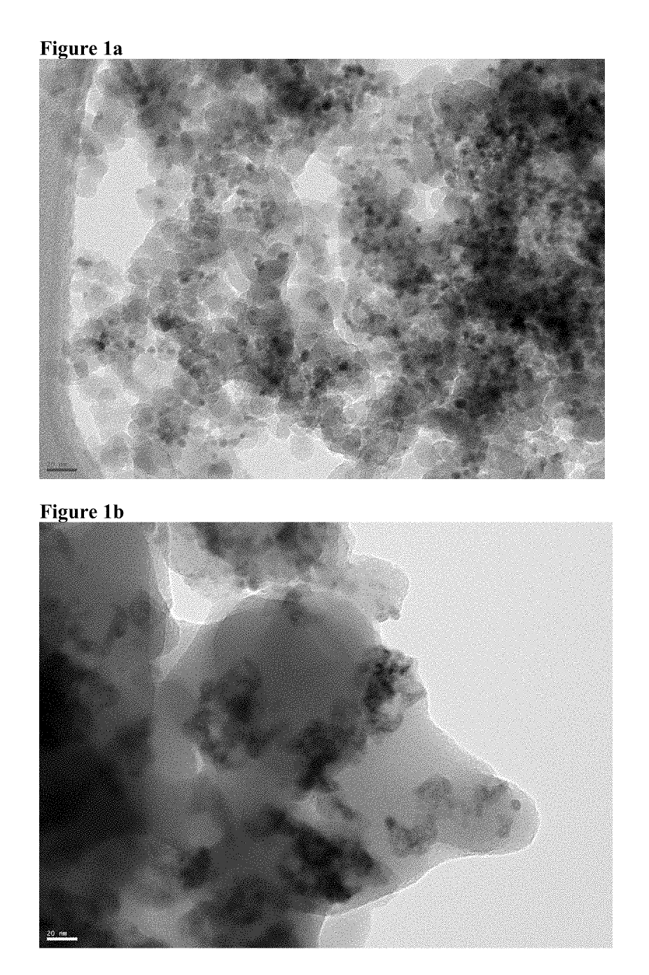

Example 1 is cerium oxide embedded with an amorphous silica matrix. The size and distribution of the CeO₂ nanocrystallites within the silica matrix revealed by transmission electron microscopy, FIG. 1a, show a random distribution of approximately equal sized nanocrystallites. Clearly, separate regions of amorphous silica and CeO₂ are present. The fine structure and porosity of the amorphous silica can be described again as randomly agglomerated domains.

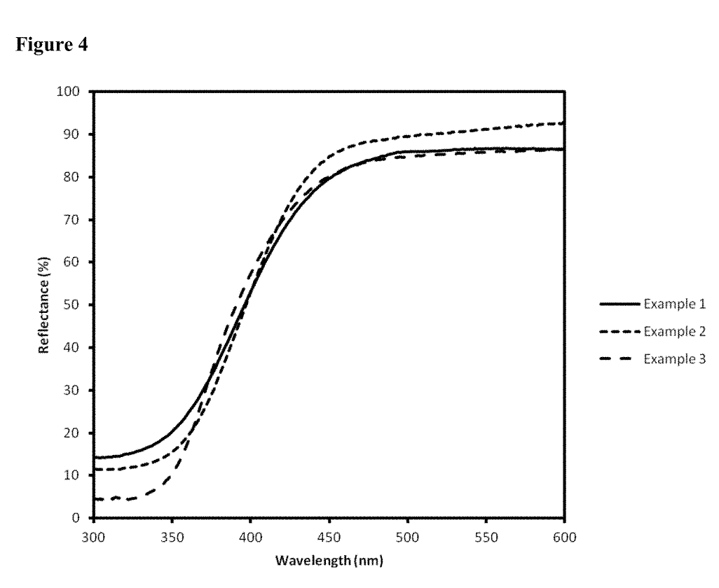

Several examples demonstrate a plurality of functional UV absorbing chemistries that include modifying the CeO₂ in amorphous silica, Example 1, with calcium or aluminum, demonstrated in Example 2 and Example 3 respectively. These variations show variations in color, see Table 1, and UV reflectance, see FIG. 4, compared to the composite of Example 1.

Encapsulation of Example 1 with amorphous silica, which occupies the pores of the amorphous silica and unifies the discrete domains, as show in FIG. 1b, yields a modified material with lower surface area, Example 4. Similar structured materials results from coatings of Example 1 material; with amorphous silica, Examples 4, 5, and 6; with zirconium oxide, Example 7; and with amorphous aluminum oxide, Example 8. These materials when dispersed within plastic matrices such as polycarbonate or polystyrene show decreased photocatalytic activity of the plastic matrix compared to Example 1.

The composite materials containing CeO₂ and a second nanocrystalline material, such as, ZnO, Example 9, and TiO₂, Example 10, have application as UV absorbers. Entraining the second nanocrystalline material in amorphous silica with CeO₂ leads to hybrid attributes that are different from the individual metal oxides. Additionally, the amorphous silica offers a measure of protection of the metal oxides from acid leaching and minimizes photocatalytic activity by separating the UV absorbing metals oxides with amorphous silica from the organic matrix. Composite materials of MoO₃, Example 11, (Co, Zn)₂SiO₄, Example 12, and SrTiO₃, Example 13, provide additional benefit as UV absorbers obtaining additional color space, see Table 1.

The particle sizes, elemental compositions, and crystal structures of each example material is presented in Tables 2 and 3. The examples are intended to be instructive but are not inclusive or exhausted examples of the claims. Particle sizes in Table 2 are of the amorphous silica containing CeO₂ materials and not the size of the CeO₂ or other example UV absorber oxides. By selecting appropriate amorphous porous silica and using typical grinding and attrition steps nearly any particle size from 100 nm to 400 μm in diameter is achievable.

The chemical compositions shown in Table 2, with their crystal structures in Table 3, are typical results for UV absorbing composites. The data demonstrate that CeO₂ nanocrystallite can be formed with an amorphous silica, Example 1; additional metals can be dissolved into the CeO₂ crystal structure within the amorphous silica, Example 3; the CeO₂ amorphous silica material can be incorporated with other metal amorphous oxides, Examples 6 thru 8; multiple metal oxides can be contained within the amorphous silica material, Examples 9 thru 13; and multiple metal oxides can be processed to multiple nanocrystallites of different crystal structures, Examples 9, 11, 12, and 13; and the amorphous silica can be converted to crystalline silica, Examples 4 and 11. When the amorphous silica is converted to crystalline silica the composite loses its transparency.

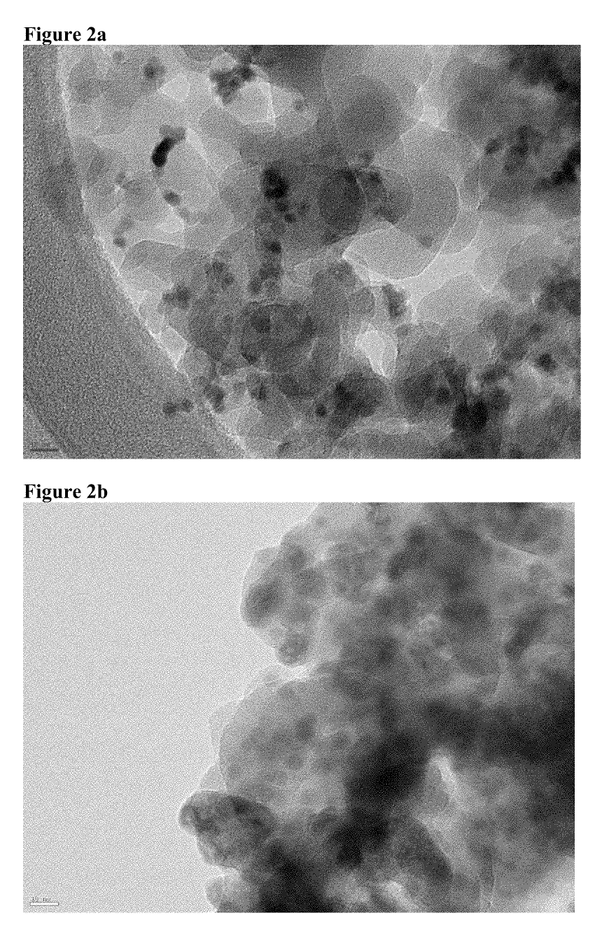

The microstructure of composite UV absorbers constructed from combinations of UV absorbing metal oxides and modified metal oxides, Example 9 thru 13, differ from the material of Example 1 and the encapsulated Examples 4 thru 8. It is believed that the concentration of nanocrystallites increases; see Example 9, FIG. 2b compared to Example 1, FIG. 2a. The increase in nanocrystal density impacts the color and UV absorption. The additional absorber concentration can lead to higher UV absorbance and lower reflectance compared to Example 1. The UV reflectance was measured from a neat powdered sample Example 14. This is demonstrated in Example 13.

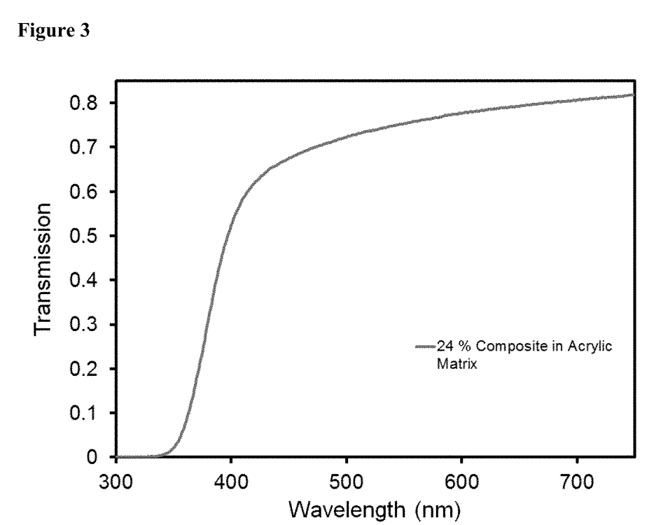

The UV absorber composite of Example 1 is dispersed in acrylic resin in Example 15. The UV spectrum, see FIG. 3, shows a strong absorption (less than 16% transmission) at wavelengths less than 370 nm. A narrow transition region occurs between 370 nm and 450 nm where transmission sharply increases, exceeding 75% transmission. The sharpness of the transition from most absorbing to mostly transparent is indicative of both the materials visual appearance and color, and clarity of articles containing the UV absorbers.

When metal oxides were added into the CeO₂ crystal structure it is believed that the crystal lattice is slightly distorted resulting in modified optical properties. The addition is done on the elemental scale by co-adding small quantity of metal salts, dopants, prior to calcining the material to insure the dopants are contained within the CeO₂ structure. An improvement in UV absorption can be see with the addition of Ca, for Example 2, and Al, for Example 3, compared to example 1, see Table 1. The UV spectra of these three Examples are shown in FIG. 4. The reflectance properties of Example 2 are decreased in the UV region as a result of increase absorption of the material compared to Example 1. An additional desirable trait is the increase of reflectance at wavelengths greater than 420 nm. Example 3 shows no change to the optical properties at wavelengths greater than 420 nm compared to Example 1, but does show increased UV absorbance compared to Examples 1 and 2 at wavelengths less than 365 nm. This improvement demonstrates the usefulness of small dopants into the CeO₂ structure to fine-tune the optical properties. A great number of additional refinements to the UV absorber composites are possible by employing other metal dopants that can tailor the optical properties of the materials.

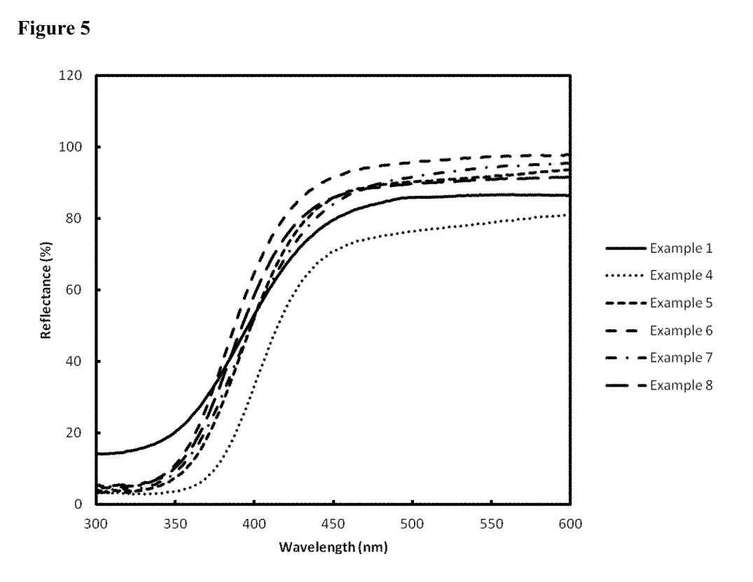

It has been found that encapsulated UV absorber composites show improvements in weathering performance, a decrease in photocatalytic activity, improved physical properties; lower specific surface area, low oil absorption, and uniform surface chemistry. Encapsulation of the composites with inorganic oxides silica, Examples 4 thru 6; zirconium, Example 7; or aluminum, Example 8, alters the optical properties as shown in FIG. 5.

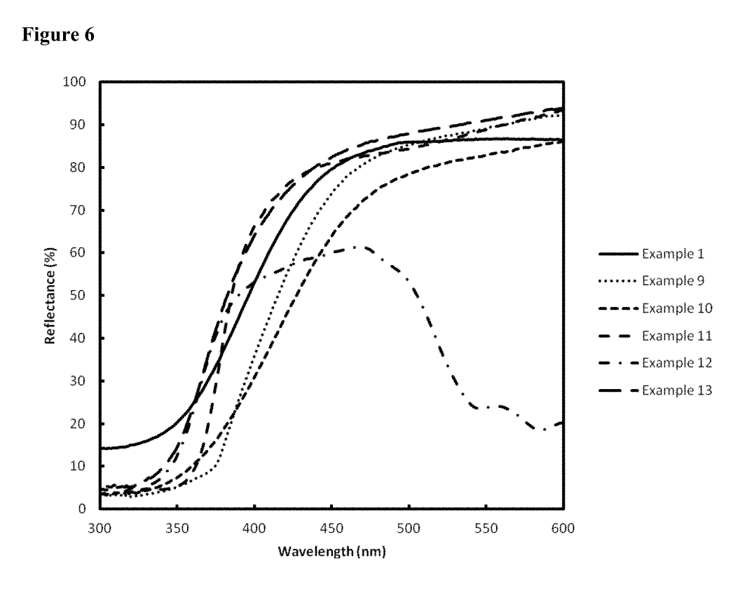

Composites containing multiple nanocrystalline materials allow fine-tuning the optical properties, such as the UV absorbing and visible properties. Examples of a second nanocrystalline material added to the UV absorber composite containing CeO₂ nanocrystalline material are: ZnO, Example 9; TiO₂, Example 10; MoO₃, Example 11; (Co, Zn)SiO₄, Example 12; and SrTiO₂, Example 13. FIG. 6 shows changes to the transition region between absorbance and transmission or reflectance. For Examples 9 and 10, the transition from absorbing to reflecting is red shifted compared to Example 1, resulting in increased UV absorbance but the transitions do not completely transition to transmissions greater than 80% until 450 nm, well into the visible spectrum.

Example 11 displays a desirable sharp transition between 360 nm and 400 nm, compared to Example 1. Examples 11, 12, and 13 introduce a blue shift in the UV spectrum compared to the Example 1 material. Examples 11 and 13 improve the UV absorbing performance and decrease the visible absorbance at wavelength greater the 400 nm compared to Example 1, both desirable attributes.

Example 12 is a blue colored material, see the spectra in FIG. 6, and the color coordinates in Table 1. This demonstrates the ability to impart UV absorbance to colored materials and subsequently gives the same benefits gained from the amorphous silica to these color inorganic compositions.

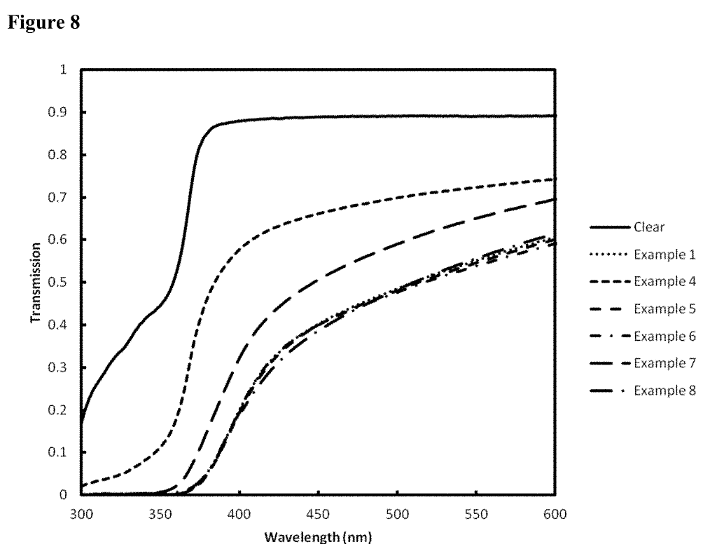

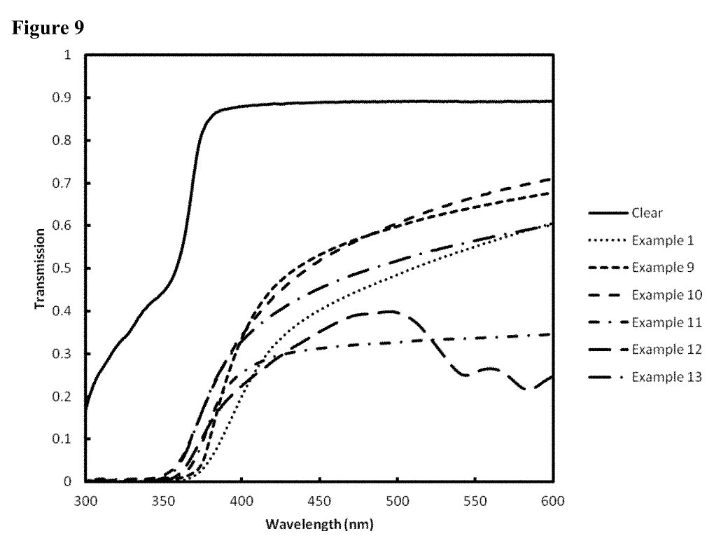

The UV absorber composites may be used in articles; plastics like polystyrene are one such example of an article that benefits from inclusion of UV absorbers. Examples 1 thru 13 were included in polystyrene chips, as shown in Example 16, and the optical transmission properties measured, as shown in FIGS. 8 and 9. The Ca and Al modified CeO₂ UV absorber composites the decrease the transmission of UV light, <375 nm compared to the clear polystyrene. Transmission percentages approaching ˜50% are reduced to <1% by inclusion of the UV absorbers. The analogous decrease in transmission is measured for the encapsulated CeO₂ amorphous silica materials show in FIG. 8. The materials with multiple nanocrystalline materials show similar trends but due to the differences in UV absorbing materials each Example 9 thru 13 had a slightly modified optical response. The differences measured in optical properties correspond well with the observations of the bulk powder spectrum shown in Example 14.

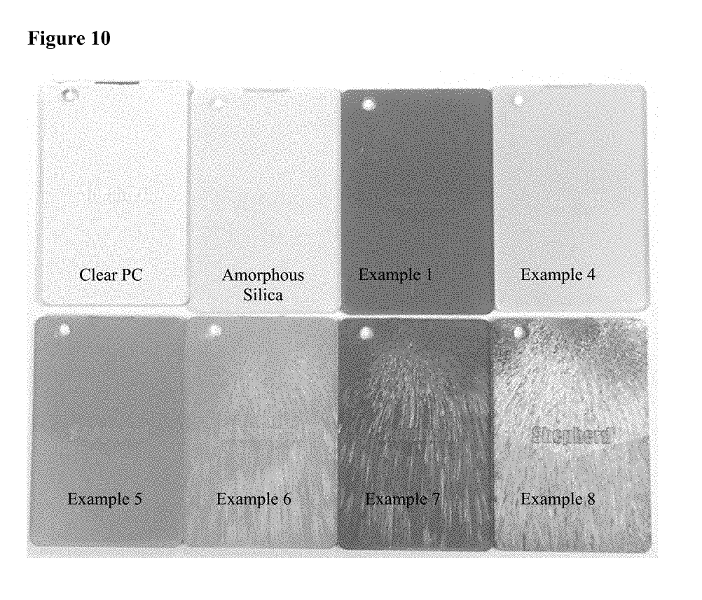

The appearance of these composites is important, ideally, for many applications clear, and colorless additives are important. Furthermore, they should not interact negatively with the composition of the matrix or article, which they are designed to protect. Color numbers like Table I combined with pictures, Example 17 are used to survey the visual properties of the example materials when deployed in articles. Several examples dispersed in polycarbonate, FIG. 10, shown discoloration due to a promoted thermal degradation process. The discoloration of the UV absorbers is pronounced for Example 1. Silica encapsulated materials, Examples 4 thru 6, have a significantly reduced discoloration and compare favorably to the amorphous silica containing chip in appearance.

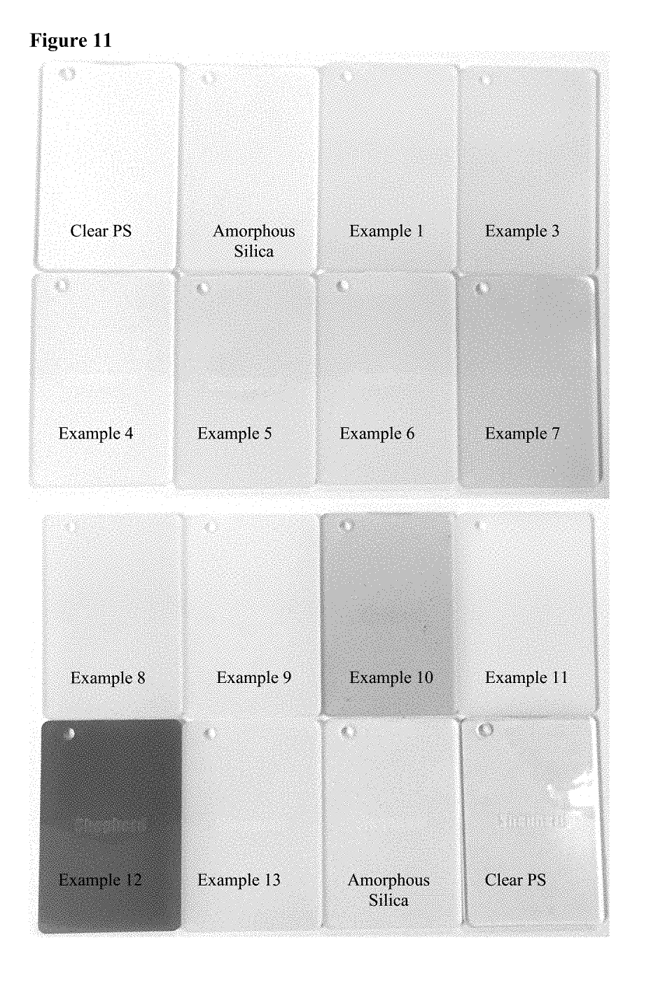

FIG. 11 shows the visual appearance of some examples in polystyrene, which closely reflects the color values of the examples in Table 1.

While the present disclosure illustrates by description several embodiments, and while the illustrative embodiments are described in considerable detail, it is not the intention of the applicant to restrict or in any way limit the scope of the appended claims to such detail. Additional advantages and modifications may readily appear to those skilled in the art.

### EXAMPLES

### Example 1—Composite of Amorphous Fumed Silica and CeO₂

Amorphous fumed silica (50 grams, 0.2 mL/g pore volume) was homogenized in the presence of a solution containing 50 grams of cerium (III) nitrate hexahydrate dissolved in 10 mL of deionized water. After complete homogenization, the mixture was then dried at 100° C. until all moisture is removed. At this time, the dried, coarse solid was pulverized into a fine powder. The off-white powder was then calcined at 500° C. for a minimum of 30 minutes or until complete precursor decomposition. The finished product was then micronized to a final particle size of approximately 2 m. The color of the composite is shown in Table 1. The color was measured by mounting a sample of neat composite into a UV-Vis spectrophotometer equipped with a diffuse reflectance sphere.

### Example 2—Composite of Amorphous Fumed Silica and Ce_{0.9}Ca_{0.2}O₂

Amorphous fumed silica (30 grams, 0.2 mL/g pore volume) was homogenized in the presence of a solution containing 29.17 grams of cerium (III) nitrate hexahydrate and 0.83 grams of calcium nitrate tetrahydrate dissolved in 6 mL of deionized water. After complete homogenization, the mixture was then dried at 100° C. until all moisture was removed. At this time the dried, coarse solid was pulverized into a fine powder. The off-white powder was then calcined at 500° C. for a minimum of 30 minutes or until complete precursor decomposition. The finished product was then micronized to a final particle size of approximately 2 μm. The color of the composite is shown in Table 1.

### Example 3—Composite of Amorphous Fumed Silica and CeAlO₃

Amorphous fumed silica (15.7 g) was homogenized in the presence of 19.9 g of an aqueous solution of Ce(NO₃)₃ and Al(NO₃)₃ (13% CeAlO₃ w/w). After complete homogenization, the mixture was then dried at 100° C. until all moisture was removed. At this time, the dried, coarse solid was ground into a powder with a mortar and pestle. The off-white powder was then calcined at 1000° C. for a minimum of 240 minutes or until complete precursor decomposition. The calcined powder was then blended in a warring blender. The color of the composite is shown in Table 1.

### Example 4—Silica Coated Composite of Amorphous Fumed Silica and CeO₂

A sample of undiluted composite material (Example 1, 10.78 g) was homogenized in the presence of 32.21 g of an aqueous solution of sodium silicate (29% SiO₂ w/w). After complete homogenization, the mixture was then dried at 100° C. until all moisture was removed. At this time, the dried, coarse solid was ground into a powder with a mortar and pestle. The off-white powder was then calcined at 500° C. for a minimum of 60 minutes or until complete precursor decomposition. The calcined powder was then ground with a mortar and pestle. The color of the composite is shown in Table 1.

### Example 5—Silica Coated Composite of Amorphous Fumed Silica and CeO₂

A sample of undiluted composite material (Example 1, 9.98 g) was homogenized in the presence of 15.8 g of tetraethyl orthosilicate (29% SiO₂ w/w). After complete homogenization, the mixture was then dried at 100° C. until all moisture was removed. At this time, the dried, coarse solid was ground into a powder with a mortar and pestle. The off-white powder was then calcined at 500° C. for a minimum of 60 minutes or until complete precursor decomposition. The calcined powder was then ground with a mortar and pestle. The color of the composite is shown in Table 1.

### Example 6—Silica Coated Composite of Amorphous Fumed Silica and CeO₂

A sample of undiluted composite material (Example 1, 58.61 g) was suspended in 1 liter of water, and the pH of the suspension was raised to 9.5 with the addition of sodium hydroxide. The slurry was heated to 90° C. and 172.5 g of an aqueous solution of sodium silicate (6.5 g SiO₂) was added at a rate of 0.7 g/min while dilute sulfuric acid was added at varying rates to keep the pH of the slurry at approximately 9.5. The slurry was cooled to room temperature and the pH was adjusted to approximately seven. It was then washed by centrifugation and then dried in air. The dry sample was then blended using a warring blender. The color of the composite is shown in Table 1.

### Example 7—Zirconia Coated Composite of Amorphous Fumed Silica and CeO₂

A sample of undiluted composite material (Example 1, 15.89 g) was homogenized in the presence of 22.75 g of Zirconium Butoxide (80% w/w 1-butanol). After complete homogenization, the mixture was then dried at 100° C. until all moisture was removed. At this time, the dried, coarse solid was ground into a powder with a mortar and pestle. The off-white powder was then calcined at 500° C. for a minimum of 60 minutes or until complete precursor decomposition. The calcined powder was ground with a mortar and pestle. The color of the composite is shown in Table 1.

### Example 8—Alumina Coated Composite of Amorphous Fumed Silica and CeO₂

A sample of undiluted composite material (Example 1, 15.89 g) was homogenized in the presence of 25.26 g of Aluminum Isopropoxide (11% w/w Isopropanol). After complete homogenization, the mixture was then dried at 100° C. until all moisture was removed. At this time, the dried, coarse solid was ground into a powder with a mortar and pestle. The off-white powder was then calcined at 500° C. for a minimum of 60 minutes or until complete precursor decomposition. The calcined powder was then ground with a mortar and pestle. The color of the composite is shown in Table 1.

### Example 9—Composite of Amorphous Fumed Silica, ZnO, and CeO₂

A sample of undiluted composite material (Example 1, 10.00 g) was homogenized in the presence of 22.89 g of an aqueous solution of Zn(NO₃)₂ (7% ZnO w/w). After complete homogenization, the mixture was then dried at 100° C. until all moisture was removed. At this time, the dried, coarse solid was ground into a powder with a mortar and pestle. The off-white powder was then calcined at 500° C. for a minimum of 60 minutes or until complete precursor decomposition. The calcined powder was then ground with a mortar and pestle. The color of the composite is shown in Table 1.

### Example 10—Composite of Amorphous Fumed Silica, TiO₂, and CeO₂

A sample of undiluted composite material (Example 1, 9.98 g) was homogenized in the presence of 16.18 g of an aqueous solution of TiOSO₄ (7% TiO₂ w/w). After complete homogenization, the mixture was then dried at 100° C. until all moisture was removed. At this time, the dried, coarse solid was ground into a powder with a mortar and pestle. The off-white powder was then calcined at 500° C. for a minimum of 60 minutes or until complete precursor decomposition. The calcined powder was then ground with a mortar and pestle. The color of the composite is shown in Table 1.

### Example 11—Composite of Amorphous Fumed Silica, MoO₃, and CeO₂

A sample of undiluted composite material (Example 1, 13.9 g) was homogenized in the presence of 18.5 g of an aqueous solution of NaMoO₄ (20% MoO₃ w/w). After complete homogenization, the mixture was then dried at 100° C. until all moisture was removed. At this time, the dried, coarse solid was ground into a powder with a mortar and pestle. The off-white powder was then calcined at 1000° C. for a minimum of 240 minutes or until complete precursor decomposition. The calcined powder was then ground with a mortar and pestle. The color of the composite is shown in Table 1.

### Example 12—Composite of Amorphous Fumed Silica, (Co,Zn)₂SiO₄, and CeO₂

A sample of undiluted composite material (Example 1, 16.7 g) was homogenized in the presence of 20.7 g of an aqueous solution of Co(NO₃)₂ and Zn(NO₃)₂ (0.001 CoZn mol/g). After complete homogenization, the mixture was then dried at 100° C. until all moisture was removed. At this time, the dried, coarse solid was ground into a powder with a mortar and pestle. The off-white powder was then calcined at 1000° C. for a minimum of 240 minutes or until complete precursor decomposition. The calcined powder was then ground with a mortar and pestle. The color of the composite is shown in Table 1.

### Example 13—Composite of Amorphous Fumed Silica, SrTiO₃, and CeO₂

A sample of undiluted composite material (Example 1, 10.0 g) was homogenized in the presence of 12.08 g of an aqueous solution of TiOSO₄ (7% TiO₂ w/w). After complete homogenization, the mixture was then dried at 100° C. until all moisture was removed. At this time, the dried, coarse solid was ground into a powder with a mortar and pestle. The off-white powder was then homogenized in the presence of 15.8 g of an aqueous solution of Sr(NO₃)₂ (22% SrCO₃ w/w). After complete homogenization, the mixture was then dried at 100° C. until all moisture was removed. At this time, the dried, coarse solid was ground into a powder with a mortar and pestle. The off-white powder was then calcined at 1000° C. for a minimum of 240 minutes or until complete precursor decomposition. The calcined powder was then ground with a mortar and pestle. The color of the composite is shown in Table 1.

### Example 14—Measuring the UV Reflectance of Examples 1-13

The UV reflectance of a sample of powdered, undiluted composite material in a cuvette was measured using a UV-Vis spectrophotometer with a diffuse reflectance sphere (specular reflectance included). The spectra are shown in FIGS. 4, 5, and 6.

TABLE 1
Color of Examples 1-13

| | | | | % Reflectance |
|---|---|---|---|---|
| Example | L* | a* | b* | (375 nm) |
| Example 1 | 97.15 | −2.31 | 6.47 | 33% |
| Example 2 | 97.16 | −1.55 | 6.31 | 27% |
| Example 3 | 94.16 | −1.32 | 4.95 | 34% |
| Example 4 | 91.08 | −1.28 | 8.1 | 10% |
| Example 5 | 96.68 | −0.99 | 5.7 | 23% |
| Example 6 | 98.78 | −1.29 | 4.58 | 34% |
| Example 7 | 97.48 | −1.94 | 7.99 | 26% |
| Example 8 | 96.3 | −1.25 | 4.47 | 29% |
| Example 9 | 95.41 | −2.15 | 12.58 | 10% |
| Example 10 | 92.61 | −2.73 | 15.79 | 16% |
| Example 11 | 95.57 | 1.75 | 6.22 | 29% |
| Example 12 | 61.97 | −5.56 | −33.19 | 41% |
| Example 13 | 96.34 | −0.07 | 6.64 | 42% |

### Example 15—Visual Opacity of Example 1

Example 1 (24% w/w) was dispersed in a transparent acrylic resin system (Delstar DMR499) and applied over an inert transparent substrate, such as glass or quartz. The dry film had a minimum thickness of 35 m. The composite was considered visually non-opaque when it is greater than 70% transparent between 475-750 nm. The spectrum is shown in FIG. 3.

### Example 16 Transmission of Examples 1 and 3-13

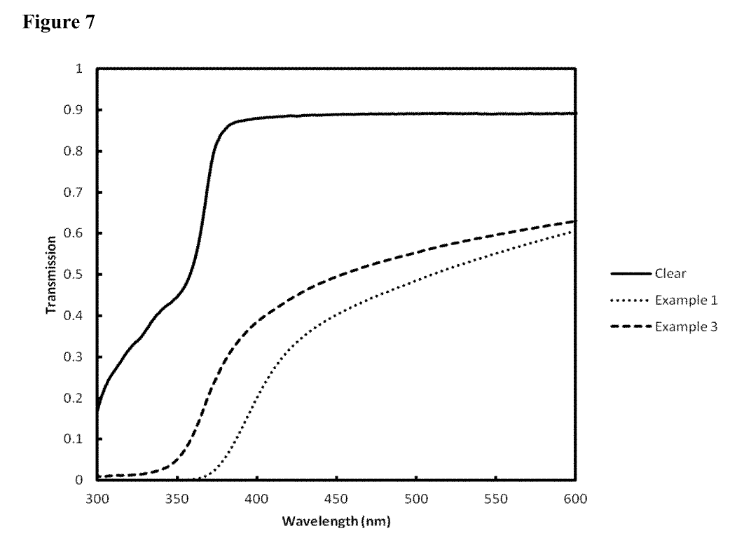

A sample of composite material (1% w/w) was dispersed in a polystyrene resin and molded into a plastic chip in an injection molder at 420° F. The transmission of each chip was measured, shown below in FIGS. 7, 8, and 9.

### Example 17 Plastic Stability of Coated Samples

A sample of composite material (1% w/w) was dispersed in a polycarbonate (PC) resin and molded into a plastic chip in an injection molder at 525° F. Pictures of the chips are shown in FIGS. 10 and 11.

TABLE 2
Particle Size and XRF Composition of Examples 1-13

| | 50 | Ce | Si | Al | Co | Hf | Mo | Na | S | Sr | Ti | Zn | Zr |
|---|---|---|---|---|---|---|---|---|---|---|---|---|---|
| Example | (μm) | (%) | (%) | (%) | (%) | (%) | (%) | (%) | (%) | (%) | (%) | (%) | (%) |
| Example 1 | 2.9 | 24 | 33 | 0 | 0 | 0 | 0 | 0 | 0 | 0 | 0 | 0 | 0 |
| Example 3 | 246.9 | 20 | 33 | 2.2 | 0 | 0 | 0 | 0 | 0 | 0 | 0 | 0 | 0 |
| Example 4 | 57.3 | 20 | 33 | 0 | 0 | 0 | 0 | 3.8 | 0 | 0 | 0 | 0 | 0 |
| Example 5 | 6.7 | — | — | — | — | — | — | — | — | — | — | — | — |
| Example 6 | 9.7 | 25 | 32 | 0 | 0 | 0 | 0 | 0 | 0 | 0 | 0 | 0 | 0 |
| Example 7 | 58.3 | 20 | 20 | 0 | 0 | 0.6 | 0 | 0 | 0 | 0 | 0.1 | 0 | 23 |
| Example 8 | 18.5 | 26 | 28 | 4.2 | 0 | 0 | 0 | 0 | 0 | 0 | 0 | 0 | 0 |
| Example 9 | 201.5 | 17 | 19 | 0 | 0 | 0 | 0 | 0 | 0 | 0 | 0 | 31 | 0 |
| Example 10 | 80.3 | 21 | 25 | 0 | 0 | 0 | 0 | 0 | 3.9 | 0 | 5.9 | 0 | 0 |
| Example 11 | 34.9 | 19 | 23 | 0 | 0 | 0 | 16 | 2.3 | 0 | 0 | 0 | 0 | 0 |
| Example 12 | 25.3 | 20 | 27 | 0 | 3.5 | 0 | 0 | 0 | 0 | 0 | 0 | 9.9 | 0 |
| Example 13 | 65.2 | 18 | 19 | 0 | 0 | 0 | 0 | 0 | 2.6 | 20 | 4.5 | 0 | 0 |

TABLE 3
XRD Composition of Examples 1, 3-5, and 6-13

| | | | | | | | | Sodium |
|---|---|---|---|---|---|---|---|---|
| | Cerium | Silicon | | | | | | Molybdenum |
| | Dioxide | Oxide | Zincite | Celestine | Willemite | Tridymite | Cristobalite | Oxide |
| | CeO₂ | SiO₂ | ZnO | SrSO₄ | Zn₂SiO₄ | SiO₂ | SiO₂ | Na₂MoO₄ |
| Example | (%) | (%) | (%) | (%) | (%) | (%) | (%) | (%) |
| Example 1 | 100 | | | | | | | |
| Example 3 | 100 | | | | | | | |
| Example 4 | 73 | 27 | | | | | | |
| Example 6 | 100 | | | | | | | |
| Example 7 | 100 | | | | | | | |
| Example 8 | 100 | | | | | | | |
| Example 9 | 59 | | 41 | | | | | |
| Example 10 | 100 | | | | | | | |
| Example 11 | 24 | | | | | 13 | 41 | 22 |
| Example 12 | 56 | | | | 44 | | | |
| Example 13 | 33 | | | 67 | | | | |

1. A UV absorber composite comprising a nanocrystalline material and an amorphous, porous material,
wherein the nanocrystalline material is in the pores of the porous material and is isolated,
wherein the nanocrystalline material comprises a cerium oxide material.

2. The composite of claim 1, wherein the nanocrystalline material has crystalline domain ranges in size from about 2 nm to about 100 nm on its longest axis, and the crystalline aspect ratio is from about 1 to about 1.5.

3. The composite of claim 1, wherein the cerium oxide material has the formula:
CeₓM_{y}O_{z},
wherein 0.5<x≤1, 0≤y≤1, and 2.0≤z≤7, and
metal M is selected from Hf⁴⁺, Ta⁵⁺, W⁴⁺, Pr³⁺, Pr⁴⁺, Nd³⁺, Pm³⁺, Sm²⁺, Sm³⁺, Eu²⁺, Eu³⁺, Gd³⁺, Tb³⁺, Tb⁴⁺, Dy³⁺, Ho³⁺, Er³⁺, Tm²⁺, Tm³⁺, Yb²⁺, Yb³⁺, Lu³⁺, V³⁺, V⁴⁺, V⁵⁺, Bi³⁺, Bi⁵⁺, Mo⁴⁺, Mo⁶⁺, Mg²⁺, Ti³⁺, Ti⁴⁺, Si⁴⁺, Zn²⁺, Al³⁺, Zr⁴⁺, La³⁺, Sb⁵⁺, Nb⁵⁺, Co²⁺, Co³⁺, Mn²⁺, Mn³⁺, Ca²⁺, Sr²⁺, Ba²⁺, Fe⁴⁺, Fe³⁺, Fe²⁺, Cr³⁺, Sn⁴⁺, Y³⁺, Cu²⁺, Cu³⁺, or mixtures thereof.

4. The composite of claim 1, comprising a second nanocrystalline material,
wherein the second nanocrystalline material is in the pores of the porous material and is isolated,
wherein the second nanocrystalline material is selected from TiO₂, ZnO, MoO₃, (Co,Zn)₂SiO₄, SrTiO₃, and mixtures thereof.

5. The composite of claim 3, comprising a second nanocrystalline material,
wherein the second nanocrystalline material is in the pores of the porous material and is isolated,
wherein the second nanocrystalline material has the formula:
CeₓM_{y}O_{z},
wherein 0.5<x≤1, 0≤y≤1, and 2.0≤z≤7, and
metal M is selected from Hf⁴⁺, Ta⁵⁺, W⁴⁺, Pr³⁺, Pr⁴⁺, Nd³⁺, Pm³⁺, Sm²⁺, Sm³⁺, Eu²⁺, Eu³⁺, Gd³⁺, Tb³⁺, Tb⁴⁺, Dy³⁺, Ho³⁺, Er³⁺, Tm²⁺, Tm³⁺, Yb²⁺, Yb³⁺, Lu³⁺, V³⁺, V⁴⁺, V⁵⁺, Bi³⁺, Bi⁵⁺, Mo⁴⁺, Mo⁶⁺, Mg²⁺, Ti³⁺, Ti⁴⁺, Si⁴⁺, Zn²⁺, Al³⁺, Zr⁴⁺, La³⁺, Sb⁵⁺, Nb⁵⁺, Co²⁺, Co³⁺, Mn²⁺, Mn³⁺, Ca²⁺, Sr²⁺, Ba²⁺, Fe⁴⁺, Fe³⁺, Fe²⁺, Cr³⁺, Sn⁴⁺, Y³⁺, Cu²⁺, Cu³⁺, or mixtures thereof.

6. The composite of claim 1, wherein the composite material is at least partially encapsulated by one or more layers selected from amorphous silica, aluminum oxide, zirconium oxide, bismuth oxide, tungsten oxide, and mixtures thereof.

7. The composite of claim 1, wherein the bulk aggregate size of the composite is from about 0.2 m to about 300 μm.

8. The composite of claim 1, wherein the porous material is selected from amorphous fumed silica, amorphous precipitated silica, naturally occurring silica, and combinations thereof.

9. The composite of claim 1, wherein the amount of nanocrystalline material does not exceed 62.5 wt % of the mass of the composite.

10. The composite of claim 1, wherein the amount of nanocrystalline material is from about 5 to about 35 wt % of the mass of the composite.

11. The composite of claim 1, wherein the composite, in its powdered, undiluted form, absorbs about 50 to about 100% of the incident light having wavelengths between 200 and 375 nm.

12. A UV absorber composite comprising a nanocrystalline material and an amorphous, porous material,
wherein the nanocrystalline material is in the pores of the porous material,
wherein the nanocrystalline material has crystalline domain ranges in size from 2 nm to about 100 nm on its longest axis, and the crystalline aspect ratio is from about 1 to about 1.5.

13. The composite of claim 12, wherein the nanocrystalline material comprises a cerium oxide.

14. The composite of claim 12, wherein the nanocrystalline material comprises the formula:
CeₓM_{y}O_{z},
wherein 0.5<x≤1, 0≤y≤1, and 2.0≤z≤7, and
metal M is selected from Hf⁴⁺, Ta⁵⁺, W⁴⁺, Pr³⁺, Pr⁴⁺, Nd³⁺, Pm³⁺, Sm²⁺, Sm³⁺, Eu²⁺, Eu³⁺, Gd³⁺, Tb³⁺, Tb⁴⁺, Dy³⁺, Ho³⁺, Er³⁺, Tm²⁺, Tm³⁺, Yb²⁺, Yb³⁺, Lu³⁺, V³⁺, V⁴⁺, V⁵⁺, Bi³⁺, Bi⁵⁺, M⁴⁺, Mo⁶⁺, Mg²⁺, Ti³⁺, Ti⁴⁺, Si⁴⁺, Zn²⁺, Al³⁺, Zr⁴⁺, La³⁺, Sb⁵⁺, Nb⁵⁺, Co²⁺, Co³⁺, Mn²⁺, Mn³⁺, Ca²⁺, Sr²⁺, Ba²⁺, Fe⁴⁺, Fe³⁺, Fe²⁺, Cr³⁺, Sn⁴⁺, Y³⁺, Cu²⁺, Cu³⁺, or mixtures thereof.

15. The composite of claim 12, comprising a second nanocrystalline material,
wherein the second nanocrystalline material is in the pores of the porous material and is isolated,
wherein the second nanocrystalline material is selected from TiO₂, ZnO, MoO₃, SrTiO₃, (Co,Zn)₂SiO₄, and mixtures thereof.

16. The composite of claim 12, wherein the composite material is at least partially encapsulated by one or more layers selected from amorphous silica, aluminum oxide, zirconium oxide, bismuth oxide, tungsten oxide, and mixtures thereof.

17. The composite of claim 12, wherein the bulk aggregate size of the composite is from about 0.2 μm to about 300 μm.

18. The composite of claim 12, wherein the porous material is selected from amorphous fumed silica, amorphous precipitated silica, naturally occurring silica, and combinations thereof.

19. The composite of claim 12, wherein ratio of nanocrystalline material to porous material is from about 5 to about 35 wt %.

20. The composite of claim 1 where in the composite is added to plastic, paint, ink, cosmetics, elastomer, rubber, packaging paper or plastic, wood coating or stain, or utilized in the presence of, or for the protection of metallic, organic, polymeric, or natural products.
